(19) United States
(12) Patent Application Publication
(10) Pub. No.: US 2016/0225355 A1
(43) Pub. Date: Aug. 4, 2016

(54) Musical Instrument Carrier

(71) Applicant: Yamaha Corporation, Hamamatsu-shi (JP)

(72) Inventor: Fumihiro SHIGENAGA, Hamamatsu-shi (JP)

(21) Appl. No.: 15/013,115

(22) Filed: Feb. 2, 2016

(30) Foreign Application Priority Data
Feb. 3, 2015 (JP) 2015-019466

(51) Int. Cl. G10G 5/00

(52) U.S. Cl. CPC G10G 5/005

(57) ABSTRACT

A musical instrument carrier that is provided includes a belly plate member arranged on the wearer's belly and provided with a support jig that supports a musical instrument, a shoulder support member arranged over the belly plate member and hung on the wearer's shoulders, and a coupling member that couples the belly plate member and the shoulder support member. The coupling member extends in the up-down direction, is removably attached to the belly plate member and the shoulder support member, and a has a bent portion in which the central axis on the side toward the belly plate member and the central axis on the side toward the shoulder support member are displaced in the front-rear direction. The coupling member having a bent portion is used to connect the shoulder support member and the belly plate member of the musical instrument carrier.

### TECHNICAL FIELD

The present invention relates to a musical instrument carrier used when the wearer supports a musical instrument with their body.

### BACKGROUND ART

In a marching band in which musical instruments are played while walking, players wear a support tool called a musical instrument carrier or a marching carrier in order to support a musical instrument such as a drum with their body. For example, the specification of U.S. Pat. No. 7,166,790 discloses a musical instrument carrier constituted by a shoulder support, a belly plate, and rod members that connect the shoulder support and the belly plate, in order for a player to support a percussion instrument such as a drum with their body.

### SUMMARY OF INVENTION

In the musical instrument carrier disclosed in the aforementioned patent document, in order to be able to adjust the position of the musical instrument to suit the player's body type, the rods that connect the shoulder plate portion and the belly plate portion are vertically divided into two portions, and a hinge for connecting the upper rods and the lower rods is provided. By making it possible to steplessly adjust the angle of the hinge, the musical instrument can be supported at a certain angle to suit the player's body type.

However, with the angle adjustment means disclosed in the aforementioned patent document that employs a hinge, the hinge is fixed by fastening sliding surfaces of the hinge with bolts, and thus there is a problem in that it becomes impossible to hold the angle of the hinge at a fixed angle when the sliding surfaces degrade due to prolonged use. In other words, there is a problem in that an attempt is made to support a heavy musical instrument such as a drum via a hinge that connects upper and lower rods, and therefore the angle of the hinge deviates during playing. There is also a problem in that the hinge becomes damaged if the bolts are forcibly tightened in order to maintain the attachment angle of the musical instrument at a fixed angle.

In this way, in the conventional musical instrument carrier, a hinge is used in order to adjust the angle at which a musical instrument is supported, and although it is possible to steplessly adjust the angle of the musical instrument, there is a problem in that the angle at which the musical instrument is supported becomes unstable as the hinge becomes degraded, and it becomes difficult to reproduce the original angle. Furthermore, the conventional musical instrument carrier requires many parts, such as shaft members, bolts, and fastening portions that have sliding surfaces with grooves formed in portions of the hinge, and this can be a cause for an increase in material cost and manufacturing cost.

In view of this, an object of one aspect of the present invention is to provide a musical instrument carrier that is highly reliable while also enabling adjustment of the position at which a musical instrument is supported.

One aspect of the present invention provides a musical instrument carrier including: a belly plate member arranged on a belly of a wearer, and provided with a support jig configured to support a musical instrument; a shoulder support member arranged over the belly plate member and configured to be hung on a shoulder of the wearer; and a coupling member configured to couple the belly plate member and the shoulder support member, wherein the coupling member extends in an up-down direction, is configured to be removably attached to the belly plate member and the shoulder support member, and a has a bent portion in which a central axis on a side toward the belly plate member and a central axis on a side toward the shoulder support member are displaced in a front-rear direction.

In another aspect of the present invention, the coupling member may be a rod-shaped member, and the cross-sectional shape thereof may be a polygon. The shoulder support member and the belly plate member may each have a holder configured to fix the coupling member, and the holders may each be provided with a recessed groove or insertion hole configured to engage with an outer surface of the coupling member.

According to the above aspects of the present invention, a coupling member having a bent portion is used to connect the shoulder support member and the belly plate member of the musical instrument carrier, and by changing the attachment angle (angle in the rotation direction) of the coupling member, it is possible to adjust the relative attachment positions of the shoulder support member and the belly plate member, while also achieving an improvement in reliability.

### BRIEF DESCRIPTION OF DRAWINGS

FIG. 1 is a perspective view of a musical instrument carrier according to an embodiment of the present invention;

FIG. 2 is a perspective view of an example of a mode of a coupling member of the musical instrument carrier according to the embodiment of the present invention;

FIGS. 3A to 3C show the structure of a holder used in the musical instrument carrier according to the embodiment of the present invention, where FIG. 3A is a plan view, FIG. 3B is a front view, and FIG. 3C is a side view;

FIGS. 4A to 4D are schematic diagrams for describing a use mode of the musical instrument carrier according to the embodiment of the present invention;

FIGS. 5A and 5B are diagrams showing the musical instrument carrier according to the embodiment of the present invention, where FIG. 5A is a front view, and FIG. 5B is a side view;

FIGS. 6A and 6B are diagrams showing the musical instrument carrier according to the embodiment of the present invention, where FIG. 6A is a front view, and FIG. 6B is a side view;

FIGS. 7A and 7B are diagrams showing the musical instrument carrier according to the embodiment of the present invention, where FIG. 7A is a front view, and FIG. 7B is a side view;

FIGS. 8A and 8B are diagrams showing the musical instrument carrier according to the embodiment of the present invention, where FIG. 8A is a front view, and FIG. 8B is a side view;

FIGS. 9A to 9E are diagrams showing other examples of cross-sectional shapes of the coupling member according to the present invention;

FIG. 10 is a diagram showing a mode of a plate used in a belly plate member of the musical instrument carrier according to the embodiment of the present invention;

FIGS. 11A to 11D are plan views of other examples of an attachment portion shown in FIG. 10; and

FIG. 12 is a diagram showing a mode of the plate used in the belly plate member of the musical instrument carrier according to the embodiment of the present invention.

### DESCRIPTION OF EMBODIMENTS

Hereinafter, an embodiment of the present invention will be described with reference to the drawings and the like. Note that the present invention can be carried out in many different modes, and is not intended to be interpreted as being limited to the content recited in the embodiment illustrated below. There are cases where the widths, thicknesses, shapes, and the like of portions are shown in a schematic manner in the drawings rather than as in actual modes in order to clarify the description, but these aspects are merely examples, and the interpretation of the present invention is not intended to be limited by such examples. Also, in this specification and the attached drawings, constituent elements similar to elements that have been previously described in connection with previous drawings are denoted by the same reference signs, and detailed descriptions thereof may be omitted as appropriate.

In this specification, unless particularly stated otherwise, cases where a certain member or region is “above (or below)” another member or region include not only cases where it is directly above (or directly below) the other member or region, but also cases where it is over (or under) the other member or region, that is to say, such cases also include cases where another constituent element is interposed over (or under) the other member or region.

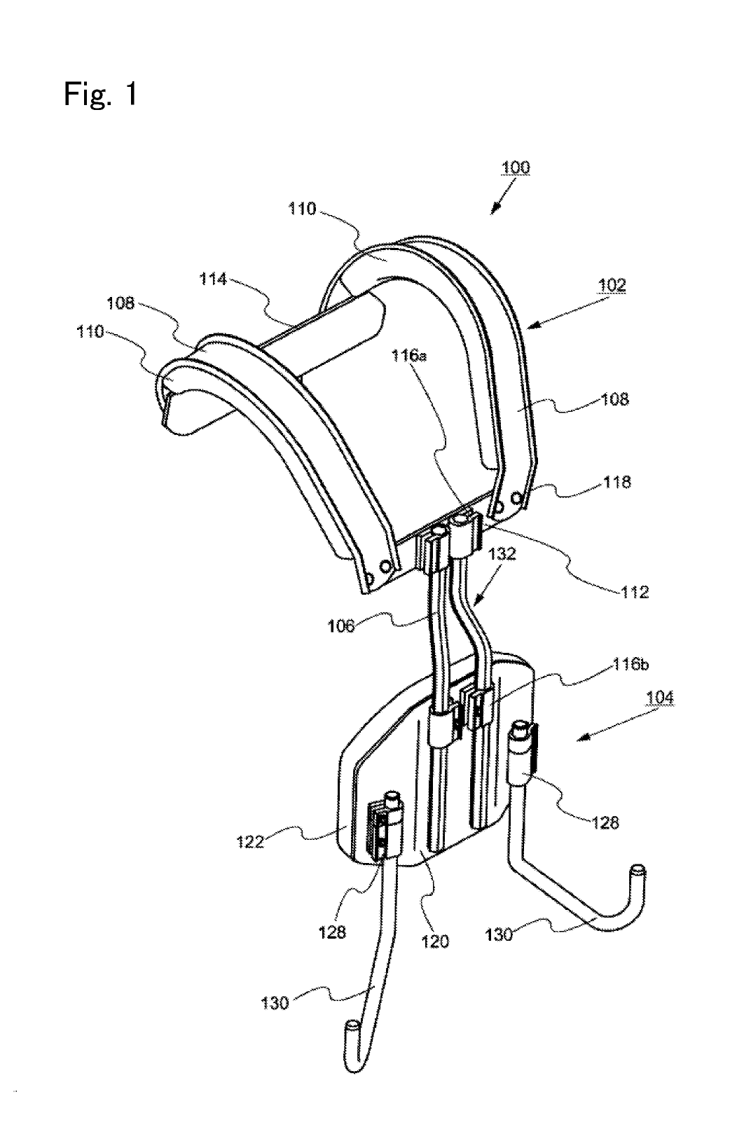

FIG. 1 is a perspective view of the overall structure of a musical instrument carrier 100 according to an embodiment of the present invention. The musical instrument carrier 100 includes a belly plate member 104, a shoulder support member 102, and coupling members 106 that connect the belly plate member 104 and the shoulder support member 102. When the musical instrument carrier 100 is worn by a player or the like, the shoulder support member 102 is arranged on the wearer's shoulders, and the belly plate member 104 is arranged on the wearer's belly.

First holders 116a are provided on the shoulder support member 102, and second holders 116b are provided on the belly plate member 104. The first holders 116a and the second holders 116b fasten and fix the coupling members 106. The shoulder support member 102 and the belly plate member 104 are coupled by the coupling members 106 being fixed by the first holders 116a and the second holders 116b. The first holders 116a and the second holders 116b hold the coupling members 106 in a removable manner, thus making it possible to adjust the relative attachment positions of the shoulder support member 102 and the belly plate member 104. For example, by adjusting the positions where the first holders 116a and the second holders 116b hold the coupling members 106 in the lengthwise direction (up-down direction) thereof, it is possible to adjust the gap between the shoulder support member 102 and the belly plate member 104 to suit the wearer's height.

The shoulder support member 102 is worn on the shoulders of the wearer of the musical instrument carrier 100. The shoulder support member 102 includes shoulder support straps 108 and an upper plate 112 and a back plate 114 that connect the shoulder support straps 108. The shoulder support straps 108 are provided at positions where the shoulder support straps are to be worn on the wearer's shoulders. It is preferable that a pair of left and right shoulder support straps 108 are provided so as to be worn on the wearer's two shoulders, but a configuration is possible in which one shoulder support strap is worn on only one shoulder.

The shoulder support straps 108 are each have a curved shape and span from the front portion of the shoulder to the rear portion thereof when the wearer wears the musical instrument carrier 100. It is preferable that the shoulder support strap 108 is flexible (bendable) to the extent of fitting to the wearer's shoulder when worn, while also having a load bearing property capable of bearing the weight of the musical instrument that the musical instrument carrier 100 supports. The shoulder support strap 108 may be formed using a metal material, for example, but may be formed using a nylon material that is both tough and flexible. Also, it is preferable that a shoulder cushion material 110 is provided on the underside (wearer side) of the shoulder support strap 108. Providing the shoulder cushion material 110 on the shoulder support strap 108 makes it possible to reduce the load on the body during wearing, and also improve wearing comfort.

The shoulder support member 102 has an upper plate 112 that is positioned on the front side of the wearer (approximately the upper chest side). Connection portions 118 for connection of the shoulder support straps 108 are provided on the upper plate 112. The connection portions 118 are arranged on the left and right sides of the upper plate 112. The left and right shoulder support straps 108 are respectively fixed by the connection portions 118 of the upper plate 112, thus making it possible to stably wear the musical instrument carrier 100.

The first holders 116a are provided on the front surface of the upper plate 112. The first holders 116a fix the coupling members 106 and hold the belly plate member 104. Providing the first holders 116a on the upper plate 112 causes the weight of supporting a musical instrument to be uniformly applied to the shoulder support straps 108, thus making it possible to improve stability during wearing.

The back plate 114 may be provided on the back side of the shoulder support member 102. The back plate 114 is connected to the shoulder support straps 108 on the wearer's back, thus making it possible to improve stability when the musical instrument carrier 100 is worn.

The positions where the shoulder support straps 108 are fixed to the upper plate 112 may be made adjustable in the left-right direction. The shoulder support straps 108 may be fixed to the upper plate 112 and the back plate 114 using fasteners such as bolts and nuts, or may be connected thereto using snap fasteners or the like such that the angle changes in the left-right direction within a certain range. By making the attachment positions on the upper plate 112 adjustable, and making the attachment angles of the shoulder support straps 108 variable, the positions of the shoulder support straps 108 can be adjusted to suit the user's body frame. Also, the shoulder support straps 108 may have an adjustment portion that enables adjustment of the length.

The belly plate member 104 includes a lower plate 120 as the main constituent element. The lower plate 120 is formed by a plate member that has rigidity and is made of a metal material, plastic, carbon fiber, or the like. It is preferable that the metal material forming the lower plate 120 is a metal material such as aluminum (Al) or titanium (Ti), or an alloy material including aluminum (Al), titanium (Ti), magnesium (mg) or the like. The lower plate 120 may have a flat plate shape, or have a shape that has a curved surface portion that curves from the front portion of the belly portion of the torso toward the side portions thereof. Forming the lower plate 120 using the aforementioned metal material or plastic makes it possible to achieve weight reduction and stably hold the musical instrument. Also, having a shape that curves along the torso makes it possible to improve wearing comfort.

The second holders 116b are attached to the front surface of the lower plate 120. The second holders 116b may be attached at any attachment position on the surface of the lower plate 120, and may be provided on the upper end side of the lower plate 120 as shown in FIG. 1, for example. Also, a configuration is possible in which the attachment positions of the second holders 116b on the surface of the lower plate 120 can be changed. As will be described later, if the attachment positions of the second holders 116b can be changed according to the shape of the coupling member 106, it is possible to adjust the attachment position of the belly plate member 104 so as to be on the front side or the back side.

A belly cushion material 122 may be provided on the back surface side of the lower plate 120, that is to say the side facing the wearer's torso. The belly cushion material 122 is formed by a shock absorbing material made of urethane resin or the like. A shock absorbing material made of urethane resin or the like can be freely molded into any shape, and thus can be given a shape that suits the torso. Providing the belly cushion material 122 on the back surface of the lower plate 120 makes it possible to prevent the hard lower plate 120 from directly coming into contact with the wearer's body, and makes it possible to improve wearing comfort. This also makes it possible to reduce to the load placed on the body by the weight of the musical instrument.

Support jigs 130 for supporting a musical instrument are provided on the lower plate 120. Various modes of support jigs can be applied as the support jigs 130 according to the type of musical instrument, the shape thereof, and the like. FIG. 1 shows an example in which the support jigs 130 are formed by rod-shaped members, and are shaped as hooks with bent tips. The support jigs 130 can be attached at various positions on the surface of the lower plate 120 in accordance with the aspects of the musical instrument, but are to be attached at positions that do not interfere with the second holders 116b. The support jigs 130 may be fixed to the lower plate 120 using fixtures 128, for example.

When a player or the like wears the musical instrument carrier 100, the belly plate member 104 comes into contact with the wearer's belly. At this time, the musical instrument is supported by the support jigs 130 provided on the lower plate 120, thus freeing the player's hands and making it possible to play the musical instrument.

The ends of the coupling members 106 on one side are coupled to the shoulder support member 102 by the first holders 116a, and the ends on the other side are coupled to the belly plate member 104 by the second holders 116b. The relative positions of the shoulder support member 102 and the belly plate member 104 are determined by the attachment positions of the coupling members 106 and the angles thereof (angles in the direction of rotation about the central axis, which is described later). It is preferable that the coupling members 106 have rigidity in order to stabilize the positions of the shoulder support member 102 and the belly plate member 104. For this reason, it is preferable that the coupling members 106 are formed from a metal material or plastic.

The coupling members 106 are shaped so as to extend in the up-down direction of the musical instrument carrier (the up-down direction along the wearer's body). For example, FIG. 1 shows an example of the case where the coupling members 106 are rod-shaped members having a polygonal cross-sectional shape. It is possible to use only one coupling member 106 formed by a rod-shaped member, but it is preferable to use at least two rod-shaped members in order to increase stability. Using at least two rod-shaped members increases stability with respect to twisting compared to using only one rod-shaped member, and makes it possible to hold a musical instrument without the shoulder support member 102 and the belly plate member 104 becoming twisted relative to each other. The rod-shaped members used as the coupling members 106 may be a member such as a rod, a tube, or a pipe.

As described above, the coupling members 106 extend in the up-down direction of the musical instrument carrier 100, the ends on one side are connected to the shoulder support member 102, and the ends on the other side are connected to the belly plate member 104. The coupling members 106 each have a bent portion 132 between the one end portion and the other end portion. Specifically, each coupling member 106 extends in the up-down direction (up-down direction along the player's body) and has a bent portion 132 whose central axes on the shoulder support member side and the belly plate member side are displaced in the front-rear direction relative to the up-down direction (the front-rear direction relative to the player's body). It is preferable that the bent portion 132 has at least two bends such that the central axes on the shoulder support member side and the belly plate member side of the coupling member 106 extend approximately parallel to each other.

The coupling members 106 can be attached to the first holders 116a and the second holders 116b with a rotated attachment direction relative to the belly plate member 104 and shoulder support member 102. Due to the coupling members 106 having the bent portions as described above, changing the attachment direction (rotation direction) makes it possible to move the relative positions of the belly plate member 104 and the shoulder support member 102 in the front-rear direction. For example, using the position of the shoulder support member 102 as a reference when the coupling members 106 are rod-shaped members as shown in FIG. 1, rotating the attachment direction of the coupling members 106 makes it possible to displace the position of the belly plate member 104 in the front-rear direction.

The musical instrument carrier 100 of the present embodiment employs the coupling members 106 that have bending portions, thus making it possible to adjust the forward-rearward relationship between the shoulder support member 102 and the belly plate member 104. Accordingly, it is possible to adjust the position at which the musical instrument is supported to suit the wearer's body. Although FIG. 1 shows the case where the coupling members 106 are rod-shaped members, similar actions and effects can be obtained even if plate-shaped members are used instead.

Note that regarding adjustment with respect to the wearer's height, adjustment in the up-down direction can be achieved by sliding the attachment positions in the lengthwise-direction of the coupling members 106 relative to the belly plate member 104 and/or the shoulder support member 102.

As illustrated in FIG. 1, the coupling members 106 are members that connect the shoulder support member 102 and the belly plate member 104. Although there are no limitations on the material for forming the coupling members 106, it is preferable that they are formed using a metal material such as aluminum (Al) or titanium (Ti), or an alloy material including aluminum (Al), titanium (Ti), magnesium (mg) or the like. Such a metal material or alloy material is lighter in weight than a steel material, while also having rigidity, and thus is suited to use in a fixture worn on the body. Note that in the case of using pipes, an increase in weight can be suppressed even if stainless steel is used.

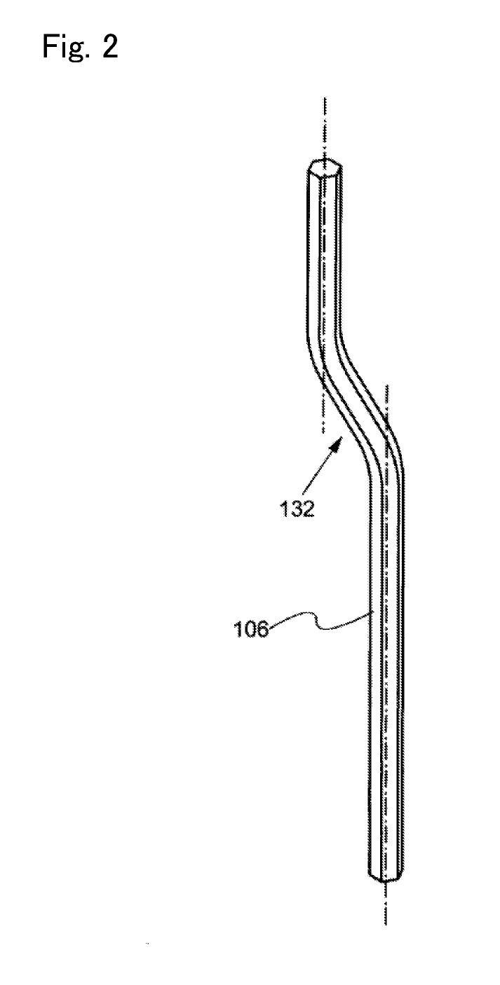

FIG. 2 shows an aspect of a rod, a tube, or a pipe as an example in the case where the coupling member 106 is a rod-shaped member. The coupling member 106 illustrated in FIG. 2 is a rod-shaped member, extends in the up-down direction, and has the bent portion 132 midway in the extending direction. The bent portion 132 is bent into at least two levels. According to this configuration, the central axis of the coupling member 106 in the upper side portion and the central axis in the lower side portion, with the bent portion 132 therebetween, do not conform to each other, but rather are shifted while being approximately parallel.

It is preferable that the cross-sectional shape of the coupling member 106 is a polygon (particularly a regular polygon). A rod-shaped member having a quadrangular, hexagonal, or octagonal cross-sectional shape, for example, can be used as the coupling member 106. When such a rod-shaped member having a polygonal cross-sectional shape is sandwiched between portions of the holder, sliding in the rotation direction is suppressed, and it is possible to prevent the fixing position in the rotation direction from fluctuating. The cross-sectional shape applied to the coupling member 106 is not limited to having up to eight sides, and may be a polygon having a larger number of sides. From the viewpoint of preventing rotation of the coupling member 106, the cross-sectional shape may be a shape such as an ellipse.

Note that although a mode in which the shoulder support member 102 and the belly plate member 104 are coupled by the coupling members 106 is given as an example in the present embodiment, the embodiment of the present invention is not limited to this mode. For example, the shoulder support member 102 and the belly plate member 104 may be coupled by a flat plate-shaped member that is bent midway in the lengthwise direction, similarly to the coupling member 106 made of a rod or a tube as shown in FIG. 2.

It is preferable that the first holders 116a and the second holders 116b are provided with recessed grooves or insertion holes that engage with the outer surface of the coupling member 106 having a polygonal cross-sectional shape. Providing the holders 116 with recessed grooves that engage with the outer shape of the coupling member 106 makes it possible to suppress movement of the coupling member in the rotation direction. Accordingly, the attachment angle of the coupling member 106 can be kept constant. For this reason, the attachment positions of the belly plate member 104 and the shoulder support member 102 are fixed, and stability and reproducibility can be improved.

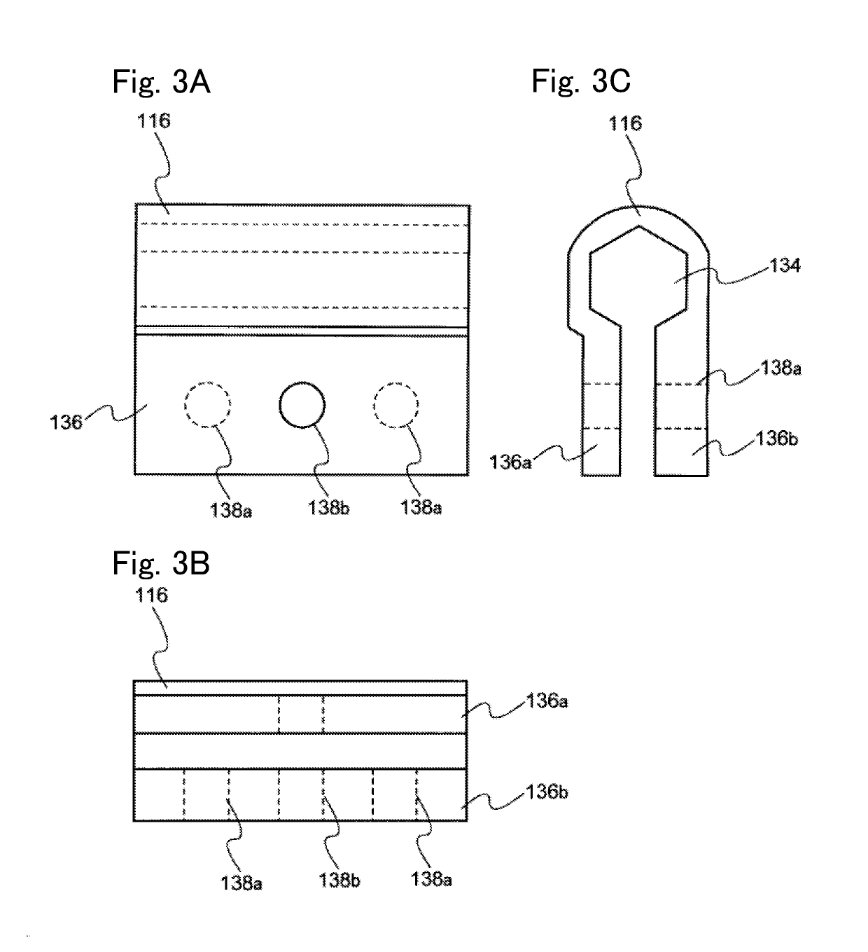

FIGS. 3A to 3C show an example of the holder 116. FIGS. 3A to 3C show an example of a holder 116 with a mode adapted to the case where the coupling member 106 is rod-shaped. FIG. 3A is a front view of the holder 116, FIG. 3B is a top view of the same, and FIG. 3C is a side view of the same. It is preferable that the holder 116 is formed using a hard material that has flexibility. Similarly to the lower plate 120, the holder 116 is formed using an alloy material containing a metal such as aluminum (Al), titanium (Ti), or magnesium (Mg).

The holder 116 has a recessed groove or insertion hole 134 that sandwiches the coupling member 106 inserted therein. As shown in FIG. 3C, a notch is formed in one end of the holder 116, and one end of the recessed groove or insertion hole 134 is free. A pair of fastening pieces 136 are provided so as to sandwich the notch portion of the recessed groove or insertion hole 134 from above and below. A lower fastening piece 136b is provided with through-holes 138a through which a fastener 139 such as a bolt is inserted for fixing to the lower plate 120 or the upper plate 112. A through-hole 138b is also provided so as to penetrate the lower fastening piece 136b and an upper fastening piece 136a.

In a state in which the lower fastening piece 136b has been fixed to the upper plate 112 or the lower plate 120, the fastener 139 such as a bolt is inserted into the through-hole 138b, a nut is screwed thereon, and the fastener 139 is tightened from the upper fastening piece 136a side, and thus the holder 116 can sandwich, crimp, and fix the coupling member 106. Due to the cross-sectional shape of the recessed groove or insertion hole 134 having an inner surface shape that is the same polygonal shape as the outer shape of the coupling member 106 in order to engage therewith, it is possible to prevent the coupling member 106 from sliding in the rotation direction.

According to the musical instrument carrier 100 of the present embodiment, depending on how the coupling members 106 are attached, it is possible to adjusting the position of the belly plate member 104 in the front-rear direction relative to the shoulder support member 102. An example of this will be described in the case where the coupling members 106 are rods or pipes having a hexagonal cross-sectional shape.

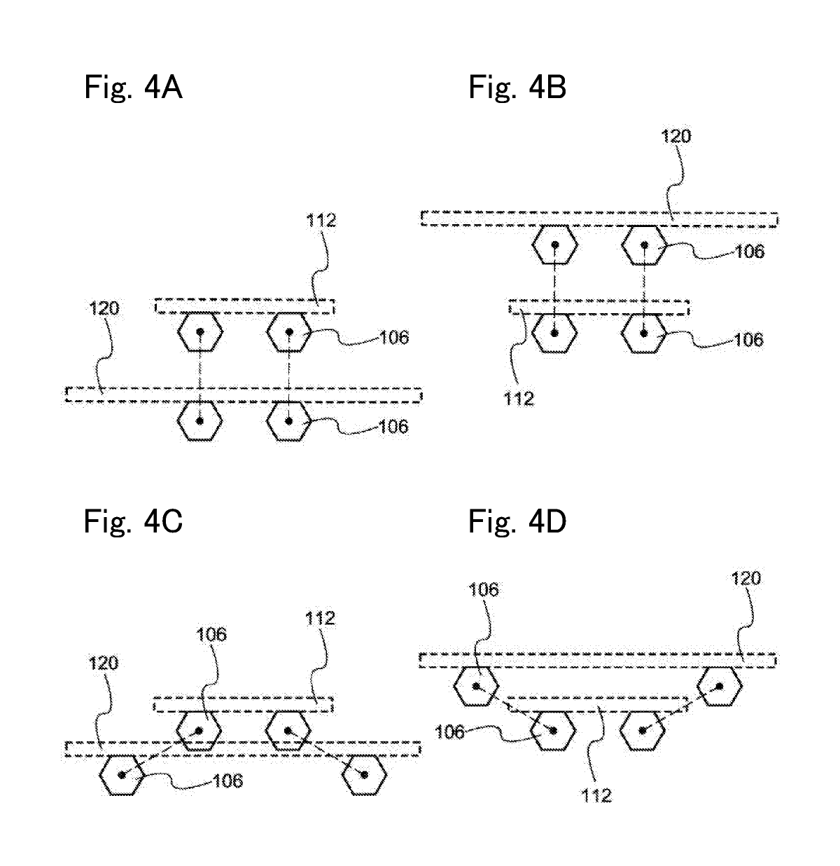

FIGS. 4A to 4D show how the position of the belly plate member 104 is adjusted in four stages in the front-rear direction using the coupling members 106 having a hexagonal cross-sectional shape. As previously described, the coupling members 106 each have the bent portion 132 between the upper end portion side fastened to the upper plate 112 and the lower end portion side fastened to the lower plate 120, and the central axes in the upper end portion and the lower end portion are displaced relative to each other. For this reason, in the case where the coupling members 106 are rod-shaped members, the position of the lower plate 120 can be changed according to the angle of attachment to the upper plate 112.

FIG. 4A shows the case where the lower plate 120 is positioned in front of the upper plate 112. In this attached state, the lower plate 120 is positioned forward by the amount of displacement obtained by the bending of the coupling members 106. In other words, FIG. 4A shows the case where the lower plate 120 is displaced at the most forward position.

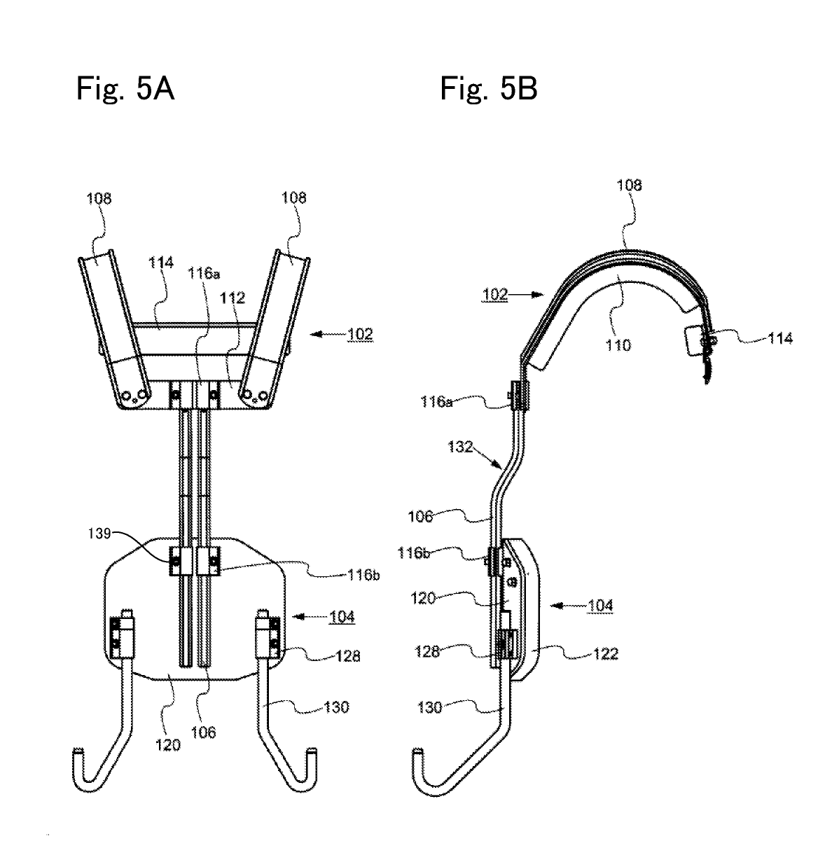

FIGS. 5A and 5B show a specific example of the attachment state described above with reference to FIG. 4A. FIG. 5A is a front view of the musical instrument carrier 100, and FIG. 5B is a side view of the same. As shown in FIG. 5B, the lower plate 120 of the musical instrument carrier 100 is arranged at a forward position relative to the position of the upper plate 112. The position of the lower plate 120 protrudes forward according to the amount that the coupling members 106 are bent. The forward displacement amount of the lower plate 120 in this state is equal to the maximum displacement amount that corresponds to the amount that the coupling members 106 are bent. By changing the amount that the coupling members 106 are bent, it is possible to change the protruding position of the lower plate 120 according to the amount of bending. Accordingly, if the coupling members 106 are replaced with other rods that are bent a different amount, it is possible to further adjust the position (maximum displacement amount) of the lower plate 120.

In this attachment state, the coupling members 106 are arranged so as to appear to be shaped as straight lines in a view from the front as shown in FIG. 5A. Specifically, the attachment positions of the coupling member 106 to the upper plate 112 and the lower plate 120 in the up-down direction are located on the same straight line. In this case, as shown in FIG. 5A, the second holders 116b attached to the lower plate 120 are attached with the recessed groove or insertion holes 134 facing inward.

FIG. 4B shows the case where the coupling members 106 are attached in a state of being rotated 180 degrees relative to the state shown in FIG. 4A. In this state, the lower plate 120 is located at a rearward position relative to the upper plate 112. In this state, the lower plate 120 is arranged rearward by an amount corresponding to the amount that the coupling members 106 are bent. In other words, the state shown here is the state in which the lower plate 120 is displaced at the most rearward position.

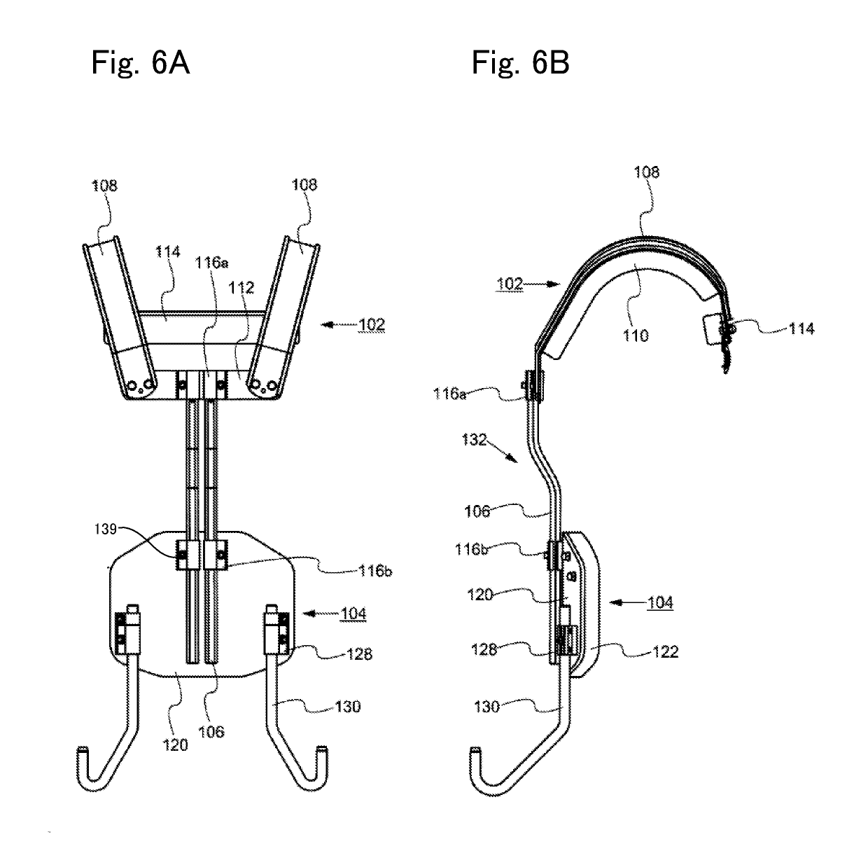

FIGS. 6A and 6B show a specific example of the attachment state described above with reference to FIG. 4B. FIG. 6A is a front view of the musical instrument carrier 100, and FIG. 6B is a side view of the same. As shown in FIG. 6B, the lower plate 120 of the musical instrument carrier 100 is arranged at a rearward position relative to the position of the upper plate 112. The position of the lower plate 120 corresponds to the amount that the coupling members 106 are bent and displaced. The rearward displacement amount of the lower plate 120 in this state is equal to the maximum displacement amount that corresponds to the amount that the coupling members 106 are bent.

In this attachment state, the coupling members 106 are arranged so as to appear to be shaped as straight lines in a view from the front as shown in FIG. 6A, similarly to FIG. 5A. In this case, as shown in FIG. 6A, the second holders 116b attached to the lower plate 120 are attached with the recessed groove or insertion holes 134 facing inward. In other words, as shown in FIGS. 5A and 6A, the second holders 116b can be attached to the lower plate 120 such that the recessed groove or insertion holes 134 can be arranged on either the right side or the left side of the fastener 139.

FIG. 4C shows the case where the coupling members 106 are attached with a rotation of 60 degrees relative to the state shown in FIG. 4A. In this attachment state, the lower plate 120 is arranged at a forward position relative to the upper plate 112, but its position is rearward compared to the case shown in FIG. 4A.

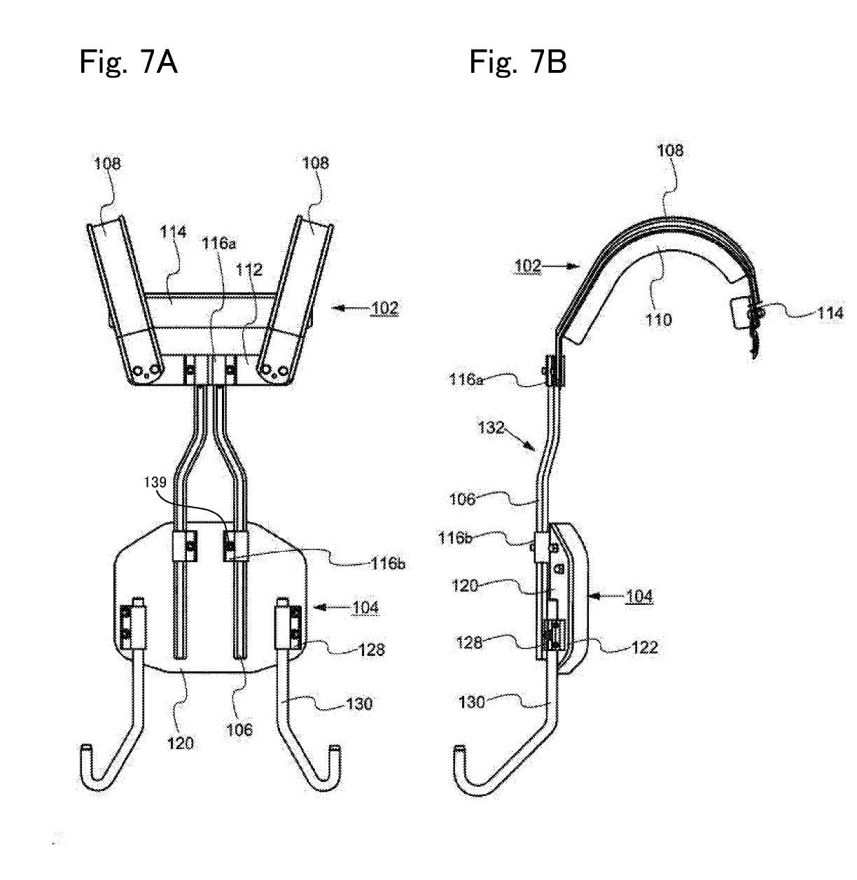

FIGS. 7A and 7B show a specific example of the attachment state described above with reference to FIG. 4C. FIG. 7A is a front view of the musical instrument carrier 100, and FIG. 7B is a side view of the same. As shown in FIGS. 7A and 7B, the lower plate 120 of the musical instrument carrier 100 is arranged at a somewhat forward position relative to the position of the upper plate 112. Also, as shown by the front view in FIG. 7A, the coupling members 106 are attached so as to be open outward. Specifically, by attaching the coupling members 106 to the upper plate 112 with a 60-degree rotation, the amount of forward displacement of the lower plate 120 decreases.

FIG. 4D shows the case where the coupling members 106 are attached with a rotation of 60 degrees relative to the state shown in FIG. 4B. In this attachment state, the lower plate 120 is arranged at a rearward position relative to the upper plate 112, but its position is forward compared to the case shown in FIG. 4B.

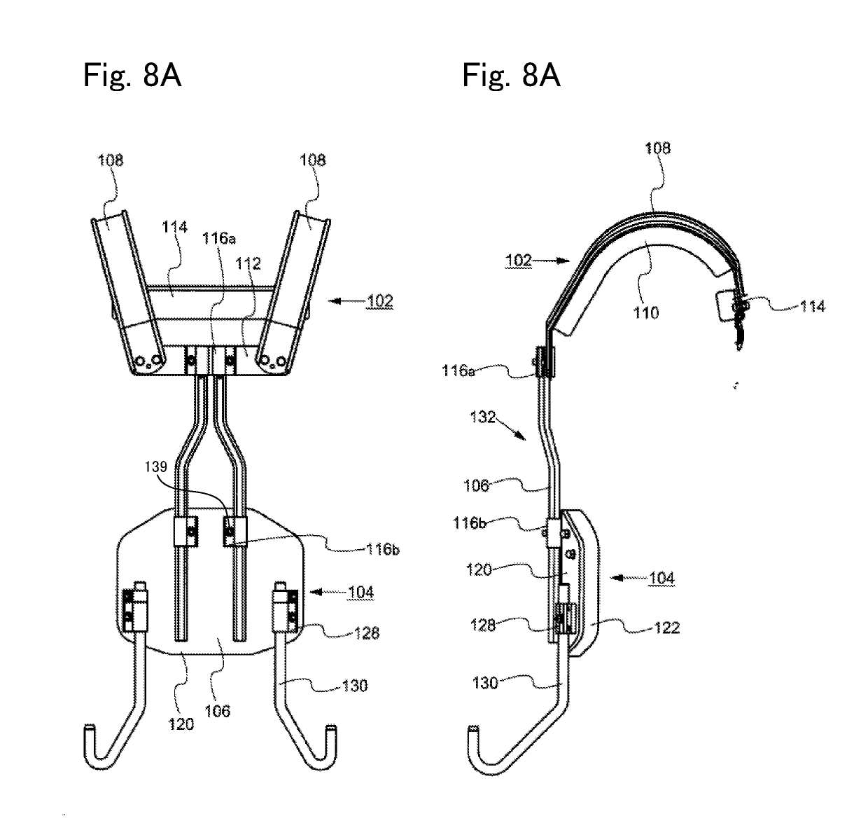

FIGS. 8A and 8B show a specific example of the attachment state described above with reference to FIG. 4D. FIG. 8A is a front view of the musical instrument carrier 100, and FIG. 8B is a side view of the same. As shown in FIG. 8B, the lower plate 120 of the musical instrument carrier 100 is arranged at a somewhat rearward position relative to the position of the upper plate 112. Also, as shown by the front view in FIG. 8A, the coupling members 106 are attached so as to be open outward. In other words, by attaching the coupling members 106 to the upper plate 112 with a 60-degree rotation relative to the state shown in FIG. 4B, the amount of rearward displacement of the lower plate 120 decreases.

As shown in FIGS. 7A and 8A, when the attachment angle of the coupling members 106 is rotated, the coupling members 106 are attached to the lower plate 120 in the state of being open outward. In this case, the coupling members 106 can be attached by rotating the positions of the recessed groove or insertion holes 134 of the second holders 116b on the lower plate 120 so as to face outward. In this way, by making it possible to change the positions of the recessed groove or insertion holes 134 so as to face inward or outward in the state in which the attachment positions of the second holders 116b are fixed, the coupling members 106 can be fixed to the lower plate 120 even if the attachment angle of the coupling members is changed. Note that although FIGS. 4A to 8B show cases where the coupling members 106 are rod-shaped members, the present invention is not limited in this way, and similar actions and effects can be obtained even if the coupling members 106 are plate-shaped members. Specifically, similarly to the case of using rod-shaped members, by using plate-shaped members having bent portions that are bent into at least two levels midway in the lengthwise direction (up-down direction), and by switching the front and reverse sides of the plate-shaped members when coupling the shoulder support member 102 and the belly plate member 104, it is possible to adjust the position of the belly plate member 104 similarly to the states shown in FIGS. 4A and 4B.

As described above, according to this embodiment of the present invention, the relative positions of the shoulder support member 102 and the belly plate member 104 can be adjusted by the attachment angle of the polygonal coupling members 106 that have bent portions. Attaching the polygonal coupling members 106 with rotations corresponding to one side, fluctuation of the relative attachment positions of the shoulder support member 102 and the belly plate member 104 is suppressed, and it is possible to achieve stability. Also, since the attachment angle of the coupling members 106 is controlled by the cross-sectional shape, it is possible to prevent misalignment caused by angle adjustment. In other words, due to using the polygonal coupling members 106 as the coupling members 106, the positions are adjusted by stepwise adjustment, thus making it possible to improve the reproducibility of the attachment position.

Furthermore, according to this embodiment of the present invention, by using rod-shaped members such as the coupling members 106 as the coupling member 106, and using the holders 116 for fixing them, it is possible to reduce the number of parts needed for front-rear adjustment of the shoulder support member 102 and the belly plate member 104, and it is possible to achieve a reduction in cost.

Although the case of using the coupling members 106 as the coupling members 106 is described in the present embodiment, the present invention is not limited in this way, and it is possible to apply a rod-shaped or columnar member such as a pipe-shaped member.

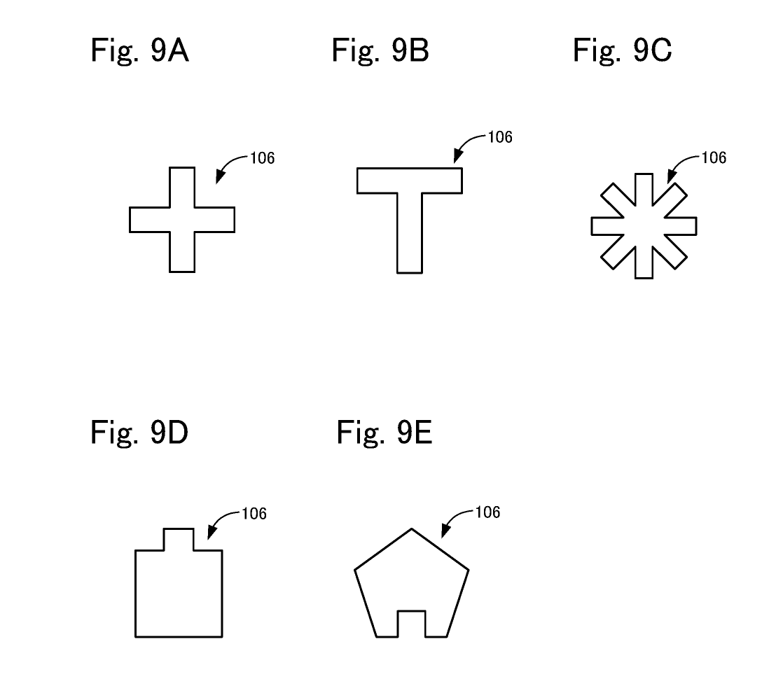

Also, there are no particular limitations on the cross-sectional shape of the coupling members 106, and besides the polygonal shapes described above, it is sufficient that the cross-sectional shape is a cross-sectional shape that does not allow rotation when the coupling members 106 are fixed to at least either the shoulder support member 102 or the belly plate member 104, such as when the coupling members 106 are fixed by being clamped as with the recessed groove or insertion holes 134. Accordingly, various types of shapes can be used, such as the cross-sectional cross shape shown in FIG. 9A, the cross-sectional T shape shown in FIG. 9B, the cross-sectional star shape shown in FIG. 9C, or the cross-sectional irregular shapes having a protrusion or recession in a portion as shown in FIGS. 9D and 9E. The holders 116 for receiving these coupling members 106, as well as the shoulder support member 102, the belly plate member 104, and the like are configured so as to correspond to the above-described cross-sectional shapes.

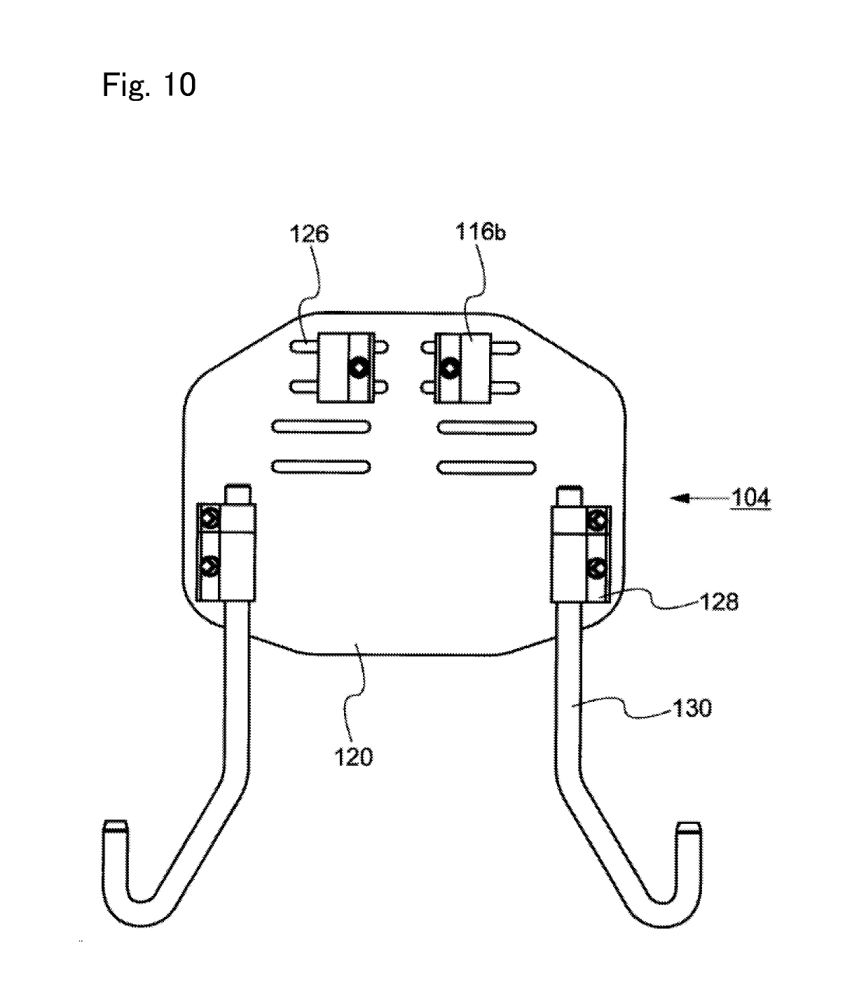

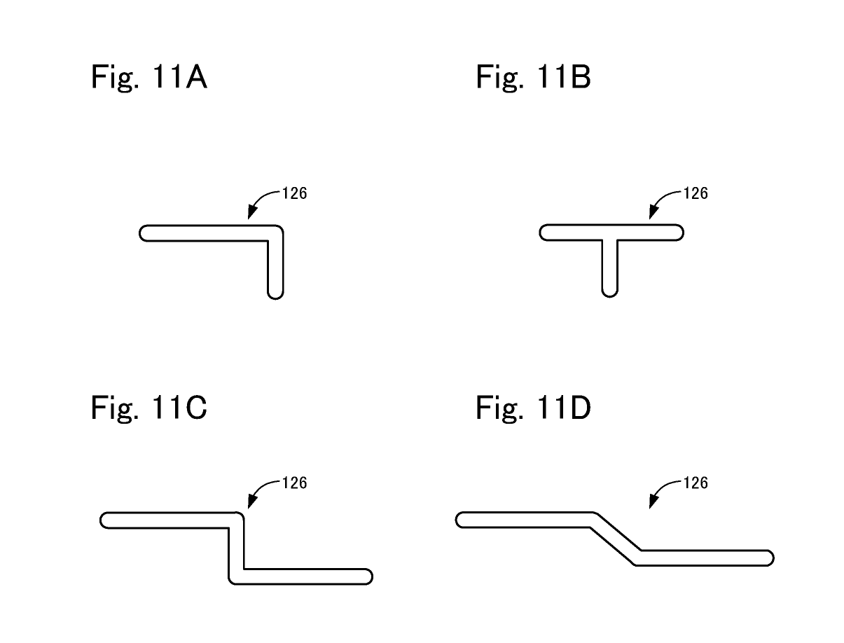

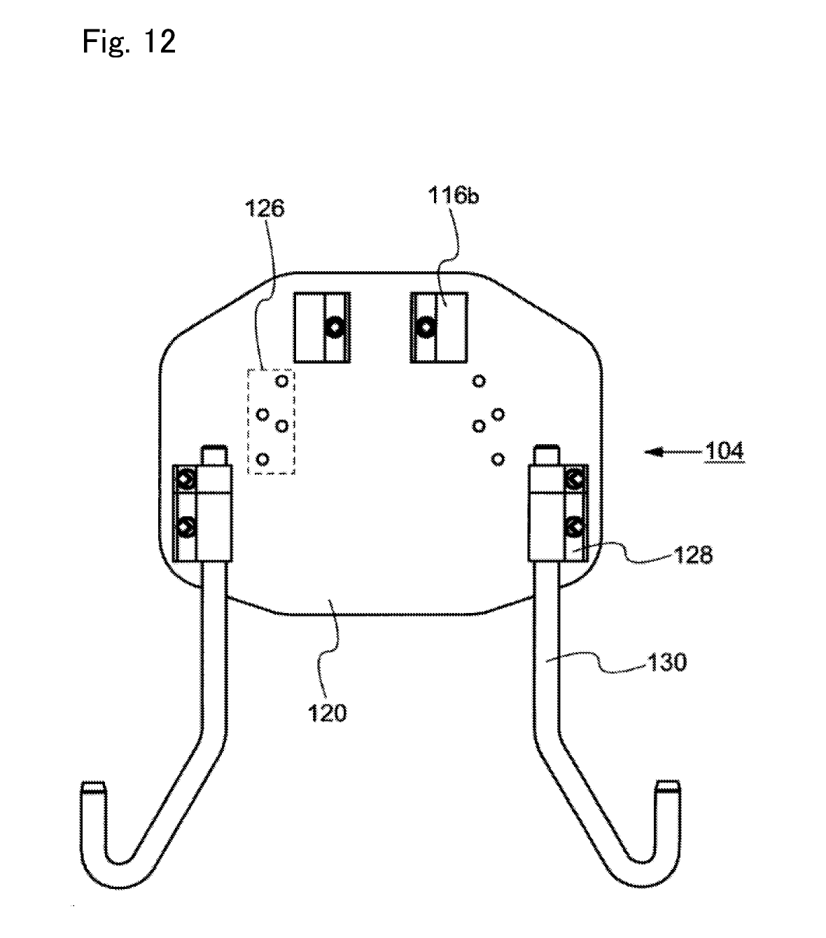

The attachment positions of the holders 116 that fix the coupling members 106 may be made adjustable. FIG. 10 shows an aspect in which attachment portions 126 formed by horizontally long through-holes (slits) are provided such that the attachment positions of the second holders 116b on the lower plate 120 can be adjusted steplessly within a certain range. Note that there are no particular limitations on the shape of the attachment portions 126, and the attachment portions 126 may extend in the horizontal direction as shown in FIG. 10, or may be combined with a slit that extends in the vertical direction as shown in FIG. 11. Also, attachment portions 126 constituted by through-holes or screw holes for attachment of the second holders 116b may be provided at multiple locations on the lower plate 120 as shown in FIG. 12.

By adding a function for adjusting the attachment positions of the holders 116 for fixing the coupling members 106, the attachment positions of the holders 116 can be adjusted according to the shape of the coupling members 106. For example, regardless of the polygonal shape of the cross-sectional shape of the rod-shaped coupling members 106, the holders 116 can fix the coupling members 106 in accordance with the attachment angle (the angle in the direction of rotation about the axis of the rod-shaped member). Accordingly, it is possible to more precisely adjust the attachment positions of the shoulder support member 102 and the belly plate member 104.

Note that although FIGS. 5A to 12 show the state of the lower plate 120 of the belly plate member 104, a similar configuration may be applied to the upper plate 112 of the shoulder support member 102, and similar actions and effects can be obtained. For example, although only the attachment of the holders 116 to the lower plate 120 has been described, a similar configuration can be applied to only the upper plate 112, or to both the upper plate 112 and the lower plate 120.

### REFERENCE SIGNS LIST

100 Musical instrument carrier

102 Shoulder support member

104 Belly plate member

106 Coupling member

108 Shoulder support strap

110 Shoulder cushion material

112 Upper plate

114 Back plate

116 Holder

118 Connection portion

120 Lower plate

122 Belly cushion material

126 Attachment portion

128 Fixture

130 Support jig

132 Bent portion

134 Recessed groove or insertion hole

136 Fastening piece

138 Through-hole

1. A musical instrument carrier comprising:
a belly plate member arranged on a belly of a wearer, and provided with a support jig configured to support a musical instrument;
a shoulder support member arranged over the belly plate member and configured to be hung on a shoulder of the wearer; and
a coupling member configured to couple the belly plate member and the shoulder support member,
wherein the coupling member extends in an up-down direction, is configured to be removably attached to the belly plate member and the shoulder support member, and a has a bent portion in which a central axis on a side toward the belly plate member and a central axis on a side toward the shoulder support member are displaced in a front-rear direction.

2. The musical instrument carrier according to claim 1, wherein the coupling member is a rod-shaped member.

3. The musical instrument carrier according to claim 2, wherein the coupling member has a shape that does not allow rotation about the central axes when fixed to the belly plate member and the shoulder support member.

4. The musical instrument carrier according to claim 3, wherein a cross-sectional shape of the coupling member is a polygon.

5. The musical instrument carrier according to claim 4, wherein the cross-sectional shape of the coupling member is a quadrangle, a hexagon, or an octagon.

6. The musical instrument carrier according to claim 3, wherein the shoulder support member and the belly plate member each have a holder configured to fix the coupling member.

7. The musical instrument carrier according to claim 6, wherein the holders are each provided with a recessed groove or insertion hole that engages with an outer surface of the coupling member.

8. The musical instrument carrier according to claim 6, wherein an attachment position of the holder of one or both of the belly plate member and the shoulder support member is adjustable according to an attachment direction of the coupling member.

9. The musical instrument carrier according to claim 8,
wherein at least one slit is formed in one or both of the belly plate member and the shoulder support member, and
the holder arranged in correspondence with the at least one slit is configured to be able to move along the at least one slit.

10. The musical instrument carrier according to claim 8,
wherein a plurality of holder fixing positions are provided in one or both of the belly plate member and the shoulder support member, and
the holder arranged in correspondence with the plurality of fixing positions is configured to be able to be removably attached to each of the fixing positions.

11. The musical instrument carrier according to claim 7,
wherein the holders are configured to be fixed to at least one out of the belly plate member and the shoulder support member by a fastener, and
the holders are each configured to be able to be fixed to at least one out of the belly plate member and the shoulder support member such that the recessed groove or insertion hole of the holder can be arranged at a position on either side of the fastener.
